(19) United States
(12) Patent Application Publication
(10) Pub. No.: US 2019/0225119 A1
(43) Pub. Date: Jul. 25, 2019

(54) VEHICLE SLIDE RAIL STRUCTURE

(71) Applicant: SHIROKI CORPORATION, Fujisawa-shi (JP)

(72) Inventors: Takuya NISHIO, Fujisawa-shi (JP); Haruki SETO, Fujisawa-shi (JP); Koji KUMAGAI, Toyokawa-shi (JP)

(73) Assignee: SHIROKI CORPORATION, Fujisawa-shi (JP)

(21) Appl. No.: 16/253,761

(22) Filed: Jan. 22, 2019

(30) Foreign Application Priority Data
Jan. 24, 2018 (JP) 2018-009542

(51) Int. Cl. B60N 2/07; B60N 2/08

(52) U.S. Cl. CPC B60N 2/0715; B60N 2/08; B60N 2/0722

(57) ABSTRACT

According to one embodiment, a vehicle slide rail structure includes: a lower rail including a bottom wall extending in a first direction; an upper rail attached to the lower rail; a member including a first surface, two ends in a second direction intersecting the first direction, a continuous region, a first fitting element, and a second fitting element and attached to the bottom wall, the first surface facing the bottom wall, the two ends being on the first surface, the continuous region being of the first surface continuous between the two ends in the second direction; and a projection located between the first fitting element and the second fitting element in the first direction, protruding from the continuous region, and configured to abut against the bottom wall to elastically deform the member such that the first fitting element and the second fitting element are pressed against the bottom wall.

### CROSS-REFERENCE TO RELATED APPLICATIONS

This application is based upon and claims the benefit of priority from Japanese Patent Application No. 2018-009542, filed Jan. 24, 2018, the entire contents of which are incorporated herein by reference.

### FIELD

Embodiments of the present invention relate to a vehicle slide rail structure.

### BACKGROUND

Conventionally, vehicle slide rail structures are known, which include a lower rail installed on the floor of the vehicle, an upper rail fixed to a seat and movably attached to the lower rail, and a member attached to the lower rail. The member is attached to the lower rail so as to help removal of a foreign object such as a lighter, for example.

Such a member includes, for example, a main body extending in the lengthwise direction of the vehicle, and two walls extending downward from opposite ends of the main body in the width direction of the vehicle. The main body inclines downward toward the forefront of the vehicle. A foreign object, when entered in the lower rail, is pushed by the upper rail to move onto the member along a sloping face of the main body and then is discharged out of the lower rail. The member elastically deforms with projections, at the bottom ends of the respective walls, serving as fulcrums, which prevents a backlash between the member and the lower rail being in contact with each other (Japanese Laid-open Patent Publication No. 2017-035911).

However, the member including the main body and the walls as described above has a substantially U-shaped cross-section. Because of this, the member is pressed from above by another object, such as a foreign object, pushed by the upper rail, and the two walls are deformed and opened, which may cause displacement of the projections that serve as fulcrums for the elastic deformation, for example.

The present invention aims to provide a vehicle slide rail structure which can prevent change of the contact position between the projections and the lower rail.

### SUMMARY

According to one embodiment of the present invention, for example, a vehicle slide rail structure includes: a lower rail including a bottom wall extending in a first direction; an upper rail movably attached to the lower rail in the first direction; a member including a first surface, two ends in a second direction intersecting the first direction and along the first surface, a continuous region, a first fitting element, and a second fitting element and configured to be attached to the bottom wall with the first fitting element and the second fitting element, the first surface facing the bottom wall, the two ends being on the first surface, the continuous region being of the first surface continuous between the two ends in the second direction, the second fitting element being spaced apart from the first fitting element in the first direction; and at least one projection located between the first fitting element and the second fitting element in the first direction, protruding from the continuous region, and configured to abut against the bottom wall to elastically deform the member such that the first fitting element and the second fitting element are pressed against the bottom wall. Therefore, in one example, in a case that another object abuts on the member to press the member in a direction in which the first surface faces, the member is relatively prevented from deforming in a periphery of the projection by the projection protruding from the continuous region. Consequently, regardless of whether the member is pressed, the projection can continuously abut on the bottom wall of the lower rail at a desired position. Thus, a position in which the projection abuts against the bottom wall is stabilized, preventing a backlash between the member and the bottom wall.

In the vehicle slide rail structure, for example, the at least one projection includes two projections, and the two projections protrude from the two ends. Therefore, in one example, a position in which the projection abuts against the bottom wall is stabilized, preventing a backlash between the member and the bottom wall.

In the vehicle slide rail structure, for example, the two projections are aligned with each other as viewed from the second direction. Therefore, in one example, the member is prevented from elastically deforming in a twisting manner with the projection being in abutment against the bottom wall.

In the vehicle slide rail structure, for example, the member includes a second surface opposite the first surface, and a protruding wall protruding from the second surface and extending in the first direction. Therefore, in one example, the protruding wall can support, for example, a foreign object in an upright or slanting state and help the upper rail push the foreign object out of the lower rail, if the foreign object enters the inside of the lower rail.

In the vehicle slide rail structure, for example, in the first direction, a distance between each of the projections and the first fitting element is shorter than a distance between each of the projections and the second fitting element. Therefore, in one example, with the member elastically deformed by the projection, the force with which the first fitting element is pressed against the bottom wall is larger than the force with which the second fitting element is pressed against the bottom wall. Thus, the first fitting element, between the first fitting element and the second fitting element, is pressed against the bottom wall with larger force, which can prevent a backlash between the member and the bottom wall.

In the vehicle slide rail structure, for example, the bottom wall includes a third surface facing the first surface, a fourth surface opposite the third surface, a first hole, and a second hole, the first hole opening to the third surface and the fourth surface, the second hole opening to the third surface and the fourth surface and spaced apart from the first hole in the first direction, the member is attached to the bottom wall with the first fitting element and the second fitting element inserted through the first hole and the second hole, respectively, the at least one projection abuts against the third surface such that the member is elastically deformed to press a first contact of the first fitting element and a second contact of the second fitting element against the fourth surface, and in a third direction in which the first surface faces, a distance between the first contact and the first surface is longer than a distance between the second contact and the first surface. Therefore, in one example, by the elastic deformation of a plate element by the projection, the first contact, which is likely to separate from the fourth surface, is pressed against the fourth surface with large force. Consequently, the first contact is prevented from separating from the fourth surface, more effectively preventing a backlash between the plate element and the bottom wall.

### BRIEF DESCRIPTION OF THE DRAWINGS

FIG. 1 is a side view schematically illustrating a seat unit in a first embodiment;

FIG. 2 is an exploded perspective view illustrating a part of a slide rail structure in the first embodiment;

FIG. 3 is a cross-sectional view illustrating a lower rail and an upper rail in the first embodiment;

FIG. 4 is a perspective view illustrating a first foreign-object interference member in the first embodiment;

FIG. 5 is a perspective view illustrating the first foreign-object interference member in the first embodiment from a direction different from the direction in FIG. 4;

FIG. 6 is a cross-sectional view illustrating the first foreign-object interference member and a bottom wall in the first embodiment;

FIG. 7 is a bottom view illustrating the first foreign-object interference member in the first embodiment;

FIG. 8 is a cross-sectional view of the first foreign-object interference member and a part of the bottom wall in the first embodiment, taken along the F8-F8 line in FIG. 7;

FIG. 9 is a perspective view illustrating the first foreign-object interference member and a part of the lower rail by which a second fitting element is caught in the first embodiment;

FIG. 10 is a perspective view illustrating the first foreign-object interference member and a part of the lower rail into which a first fitting element is fitted in the first embodiment;

FIG. 11 is a perspective view illustrating a second foreign-object interference member in the first embodiment;

FIG. 12 is a perspective view illustrating the second foreign-object interference member in the first embodiment from a direction different from the direction in FIG. 11;

FIG. 13 is a perspective view of a part of a lower rail to which a first foreign-object interference member is attached, in a second embodiment; and

FIG. 14 is a cross-sectional view illustrating a part of the lower rail and a part of the first foreign-object interference member in the second embodiment.

### DETAILED DESCRIPTION

### First Embodiment

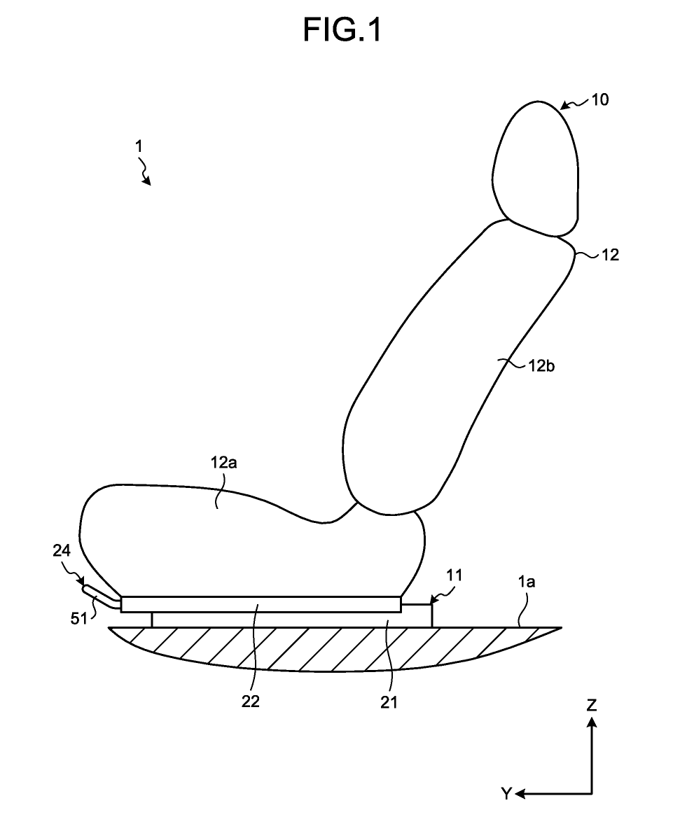

The following describes a first embodiment with reference to FIG. 1 to FIG. 12. Basically, the present description defines an upward direction as being vertically upward and a downward direction as being vertically downward. In the present description, a plurality of expressions may be used for describing a constituent element according to an embodiment or a description thereof. Another expression not used herein may be used for describing any constituent element or a description for which such a plurality of expressions are used. Another expression not used herein may be used also for describing any constituent element or a description for which a plurality of expressions are not used.

FIG. 1 is a side view schematically illustrating a seat unit 10 in a first embodiment. The seat unit 10 is installed on a vehicle 1 such as a four-wheeled automobile, and includes a slide rail structure 11 and a seat 12. The seat 12 includes a seat cushion 12a and a seat back 12b turnably attached to the seat cushion 12a.

As illustrated in the drawings, X-axis, Y-axis, and Z-axis are defined in the present description. The X-axis, the Y-axis, and the Z-axis are perpendicular to one another. The X-axis is along the lateral of the vehicle. The Y-axis is along the length of the vehicle. The Z-axis is along the height of the vehicle.

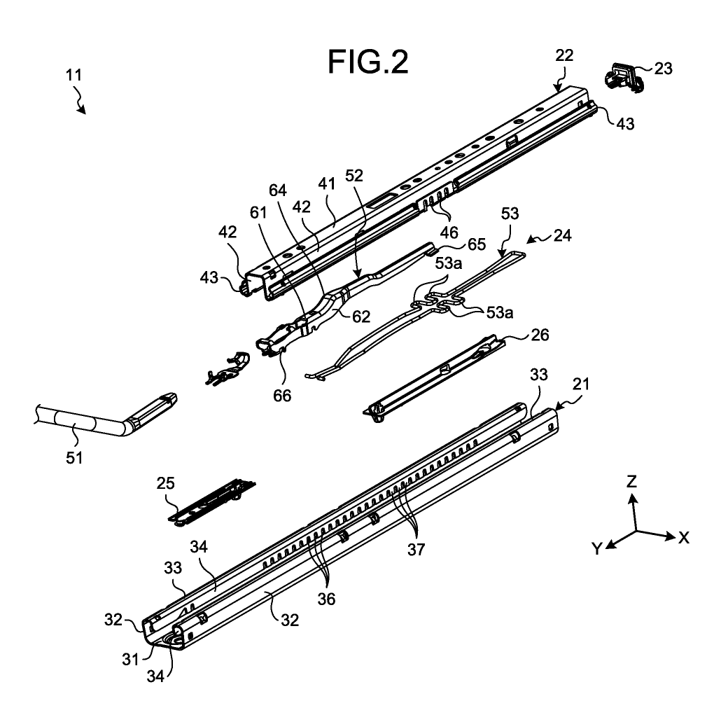

FIG. 2 is an exploded perspective view illustrating a part of the slide rail structure 11 in the first embodiment. The slide rail structure 11 includes two lower rails 21, two upper rails 22, two caps 23, a locking mechanism 24, two first foreign-object interference members 25, and two second foreign-object interference members 26. FIG. 2 illustrates one of the lower rails 21, one of the upper rails 22, one of the caps 23, one of the first foreign-object interference members 25, and one of the second foreign-object interference members 26. Each of the first foreign-object interference members 25 and second foreign-object interference members 26 may also be referred to as a member or a plate element.

The lower rail 21 is attached to a floor 1a of the vehicle 1 in FIG. 1, extending in a Y-axis direction (the lengthwise direction of the vehicle 1). That is, in the present embodiment, a longitudinal direction of the lower rail 21 coincides with the lengthwise direction of the vehicle 1. The Y-axis direction may also be referred to as a first direction. The two lower rails 21 are spaced from each other in an X-axis direction (lateral direction of the vehicle 1). In the present embodiment, a width direction of the lower rail 21 coincides with the lateral direction of the vehicle 1.

The upper rail 22 is attached to the lower rail 21, extending in the Y-axis direction, and is slidable in the Y-axis direction. For example, a rolling element placed between the lower rail 21 and the upper rail 22 enables the upper rail 22 to smoothly move on the lower rail 21. The two upper rails 22 support the seat 12 illustrated in FIG. 1.

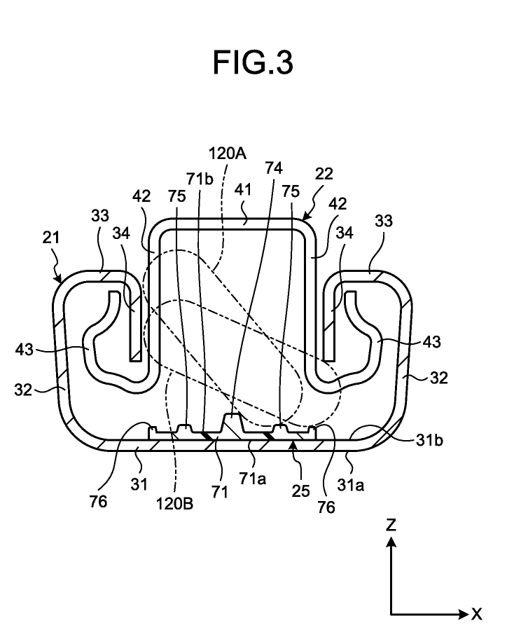

FIG. 3 is a cross-sectional view illustrating the lower rail 21 and the upper rail 22 in the first embodiment. As illustrated in FIG. 3, the lower rail 21 is made of one metal plate by bending and has a substantially C-shaped cross-section. The lower rail 21 is not limited to this example. The lower rail 21 includes a bottom wall 31, two outer side walls 32, two connective walls 33, and two inner side walls 34.

The bottom wall 31 is plate-like, the bottom wall 31 laid on the X-Y plane and extending in the Y-axis direction. The bottom wall 31 includes a bottom surface 31a and an inner surface 31b. The bottom surface 31a may also be referred to as a fourth surface. The inner surface 31b may also be referred to as a third surface. The bottom surface 31a is substantially flat and faces the floor la in FIG. 1. The inner surface 31b is opposite to the bottom surface 31a and is substantially flat. The bottom wall 31 is attached to the floor 1a, for example, with bolts or rivets.

In the cross-section in FIG. 3, the two outer side walls 32 extend in a positive Z-axis direction from the opposite ends of the bottom wall 31 in the X-axis direction. The positive Z-axis direction is a direction indicated by the arrow of the Z-axis, and is upward in the present embodiment.

In the cross-section in FIG. 3, the two inner side walls 34 are located between the two outer side walls 32 and extend in a Z-axis direction. In the X-axis direction, the two inner side walls 34 are spaced from each other away from the two outer side walls 32. The connective walls 33 connect the top ends of the outer side walls 32 and the top ends of the inner side walls 34. The bottom ends of the inner side walls 34 are spaced from the bottom wall 31.

As illustrated in FIG. 2, the inner side walls 34 are each provided with a plurality of locking grooves 36. The locking grooves 36 are cutouts opening to the bottom ends of the inner side walls 34 and extending upward. The locking grooves 36 form teeth 37 in the inner side wall 34.

As illustrated in FIG. 3, the upper rail 22 is made of one metal plate by bending. The upper rail 22 is not limited to this example. The upper rail 22 includes a top wall 41, two insertion walls 42, and two curved walls 43.

The top wall 41 is plate-like, the top wall 41 laid on the X-Y plane and extending in the Y-axis direction. The top wall 41 is located outside the lower rail 21. In the cross-section in FIG. 3, the two insertion walls 42 extend in a negative Z-axis direction from the X-axial opposing ends of the top wall 41. The negative Z-axis direction is a direction opposite to the arrow of the Z-axis, and is downward in the present embodiment.

The two insertion walls 42 are inserted through a gap between the two inner side walls 34 of the lower rail 21. The curved walls 43 are located inside the lower rail 21. The curved walls 43 are bent so as to roughly extend toward the connective walls 33 of the lower rail 21 from the bottom ends of the insertion walls 42.

As illustrated in FIG. 2, each of the insertion walls 42 is provided with a plurality of stop grooves 46. The stop grooves 46 are cutouts opening to the bottom ends of the insertion walls 42 and extending upward. The stop grooves 46 are provided at substantially equal intervals in the Y-axis direction. The intervals among the stop grooves 46 are substantially equal to those among the locking grooves 36 in the lower rail 21.

The caps 23 are made from, for example, synthetic resin. The caps 23 are attached to rear ends of the upper rails 22 to close the rear ends of the upper rails 22.

The locking mechanism 24 includes a handle 51, an unlocking lever 52, and a spring 53. The locking mechanism 24 restricts (locks) sliding of the upper rails 22 on the lower rails 21. BY manipulation of the handle 51, the locking mechanism 24 unlocks the lock, making the upper rails 22 slidable on the lower rails 21.

The unlocking lever 52 is accommodated inside each of the upper rails 22. The unlocking lever 52 includes a top wall 61 and two side walls 62. The top wall 61 is roughly a plate-like part, being laid on the X-Y plane and extending in the Y-axis direction. The side walls 62 project downward from the X-axial opposite ends of the top wall 61.

The top wall 61 is provided with a salient 64 protruding upward. The salient 64 makes contact with the top wall 41 of the upper rail 22. The side walls 62 are provided with pressing tabs 65 at the rear ends. The side walls 62 are also provided with stops 66 at the front ends. The stops 66 are, for example, cutouts opening to the bottom ends of the side walls 62.

The spring 53 is made of a wire rod by bending. The spring 53 is not limited to this example. The spring 53 includes a plurality of locking parts 53a. The locking parts 53a are part of the spring 53 protruding outward from the upper rail 22 in the X-axis direction. The locking parts 53a have substantially a U-shape.

The rear end of the spring 53 and a part of the spring 53 located frontward of the locking parts 53a are supported by the upper rail 22. The locking parts 53a are fitted into the stop grooves 46 of the upper rail 22, and restricted from moving in the Y-axis and X-axis directions. The front end of the spring 53 is fitted into the stops 66 of the unlocking lever 52. The pressing tabs 65 of the unlocking lever 52 make contact with the spring 53 from above in the vicinity of the locking parts 53a.

As described above, the spring 53 attached to each of the upper rails 22 and the unlocking lever 52 presses the unlocking lever 52 toward the top wall 41 of the upper rail 22. The salient 64 is thereby pressed against the top wall 41, and the unlocking lever 52 is turnably supported by the spring 53 with the salient 64 serving as a fulcrum.

The locking parts 53a of the spring 53 are fitted into the locking grooves 36 in the lower rail 21. The upper rail 22 is thereby restricted from sliding relative to the lower rail 21. The elasticity of the spring 53 works to maintain the locking parts 53a inside the locking grooves 36.

The handle 51 is attached to the unlocking lever 52. By manipulation of the handle 51, upward external force acts on the front end of the unlocking lever 52, tuning the unlocking lever 52 around the salient 64. The pressing tabs 65 of the unlocking lever 52 press down the turning spring 53, thereby disengaging the locking parts 53a from the locking grooves 36. This releases the locking, which enables the upper rail 22 to move relative to the lower rail 21.

The first foreign-object interference members 25 and the second foreign-object interference members 26 are attached to the bottom walls 31 of the lower rails 21. The first foreign-object interference members 25 are disposed, for example, on the front ends of the bottom walls 31. The second foreign-object interference members 26 are disposed on the rear ends of the bottom walls 31. In the present embodiment, the end refers to not only the end of a member or of a part but also a part adjacent to the end. The first foreign-object interference members 25 and the second foreign-object interference members 26 may be disposed in other locations.

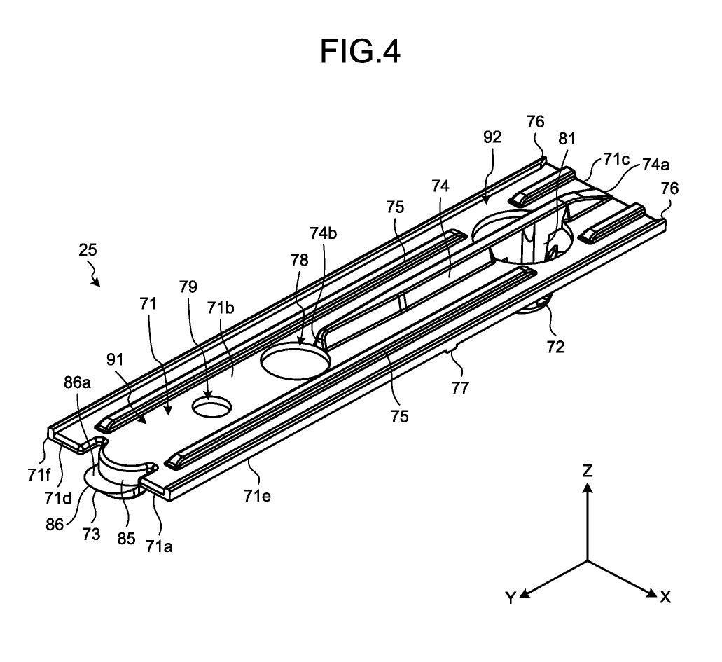

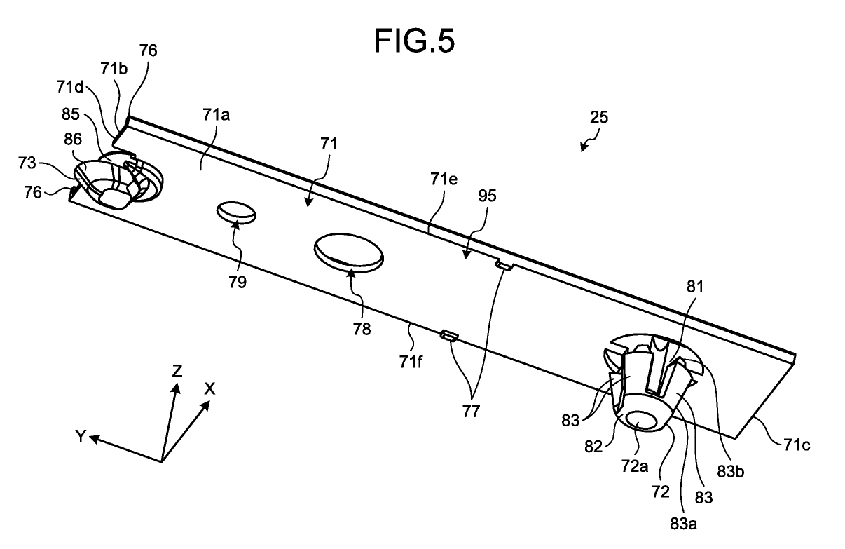

FIG. 4 is a perspective view illustrating the first foreign-object interference member 25 in the first embodiment. FIG. 5 is a perspective view illustrating the first foreign-object interference member 25 in the first embodiment from a direction different from the direction in FIG. 4. The first foreign-object interference members 25 are made from, for example, synthetic resin. The first foreign-object interference members 25 may be made from another material.

Each of the first foreign-object interference members 25 includes a plate 71, a first fitting element 72, a second fitting element 73, a first protruding wall 74, two second protruding walls 75, two third protruding walls 76, and two projections 77. Each of the first fitting element 72 and the second fitting element 73 may also be referred to as an engagement. Each of the first protruding wall 74, second protruding walls 75, and third protruding walls 76 may also be referred to as a partition.

In the present embodiment, the plate 71, the first fitting element 72, the second fitting element 73, the first protruding wall 74, the second protruding walls 75, the third protruding walls 76, and the projections 77 are integrally formed. Each of the first foreign-object interference member 25 may be formed of, for example, a plurality of members.

The plate 71 is laid on the X-Y plane and extends in the Y-axis direction. A length of the plate 71 in the Y-axis direction is longer than a length (thickness) in the Z-axis direction thereof, and is longer than a length (width) in the X-axis direction thereof.

The plate 71 has a bottom surface 71a, a top surface 71b, a first end 71c, a second end 71d, a third end 71e, and a fourth end 71f. The bottom surface 71a may also be referred to as a first surface. The top surface 71b may also be referred to as a second surface.

The bottom surface 71a is substantially flat facing substantially downward. As illustrated in FIG. 3, the bottom surface 71a faces the inner surface 31b of the bottom wall 31. In other words, the bottom surface 71a and the inner surface 31b face each other. The top surface 71b is opposite to the bottom surface 71a and is substantially flat facing substantially upward. Each of the bottom surface 71a and top surface 71b is continuous in the X-axis direction and the Y-axis direction. Each of the bottom surface 71a and top surface 71b may be, for example, a curved surface or may include irregularities.

As illustrated in FIG. 4, the first end 71c is the Y-axial end of the plate 71. The second end 71d is the opposing end of the first end 71c of the plate 71. In the present embodiment, the first end 71c and the second end 71d are in the bottom surface 71a.

In the first foreign-object interference member 25, the first end 71c is the rear end of the plate 71, and the second end 71d is the front end of the plate 71. The first end 71c and the second end 71d may be another directional ends.

As illustrated in FIG. 4, the third end 71e is one X-axial end of the plate 71. The fourth end 71f is the opposing end of the third end 71e of the plate 71. The X-axis direction is along the bottom surface 71a and the top surface 71b and may also be referred to as a second direction. In the present embodiment, the third end 71e and the fourth end 71f are in the bottom surface 71a. That is, in the X-axis direction the two ends (71e and 71f) in the bottom surface 71a are approximately in the same location as the two ends (71e and 71f) of the plate 71. In the X-axis direction the two ends of the plate 71 may be located in other locations in addition to in the bottom surface 71a.

The plate 71 is provided with a first aperture 78 and a second aperture 79. Each of the first aperture 78 and second aperture 79 may also be referred to as through hole. The first aperture 78 and the second aperture 79 penetrate the plate 71 in the Z-axis direction and each has a circular cross-section. Thus, the first aperture 78 and the second aperture 79 open to the bottom surface 71a and the top surface 71b. The bottom surface 71a and the top surface 71b face in the Z-axis direction.

The first aperture 78 and the second aperture 79 penetrate the first foreign-object interference member 25 in the Z-axis direction. That is, in the Z-axis direction, the first aperture 78 and the second aperture 79 are open, not covered by any other parts of the first foreign-object interference member 25.

The first aperture 78 and the second aperture 79 are spaced from each other in the Y-axis direction. In the X-axis direction, the first aperture 78 and the second aperture 79 are located substantially at the center of the plate 71. The first aperture 78 and the second aperture 79 may be provided in other locations.

The first foreign-object interference member 25 is attached to the bottom walls 31 of the corresponding lower rail 21 with the first fitting element 72 and the second fitting element 73. The first fitting element 72 is located at or in the vicinity of a first end 71c of the plate 71. The second fitting element 73 is located at or in the vicinity of a second end 71d of the plate 71. In other words, the second fitting element 73 is spaced apart from the first fitting element 72 in the Y-axis direction. The first fitting element 72 and the second fitting element 73 may be provided in other locations.

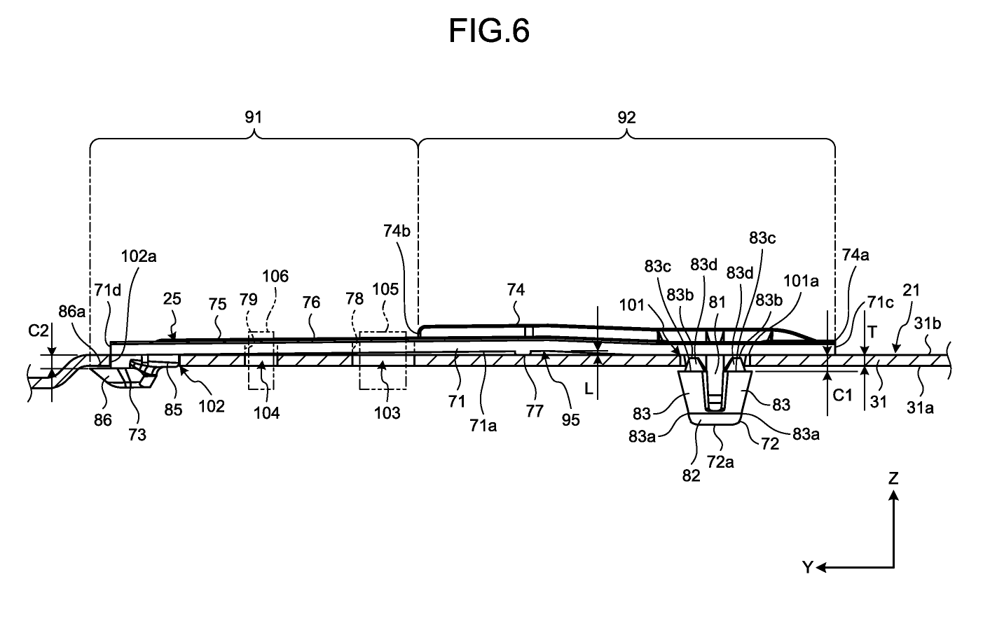

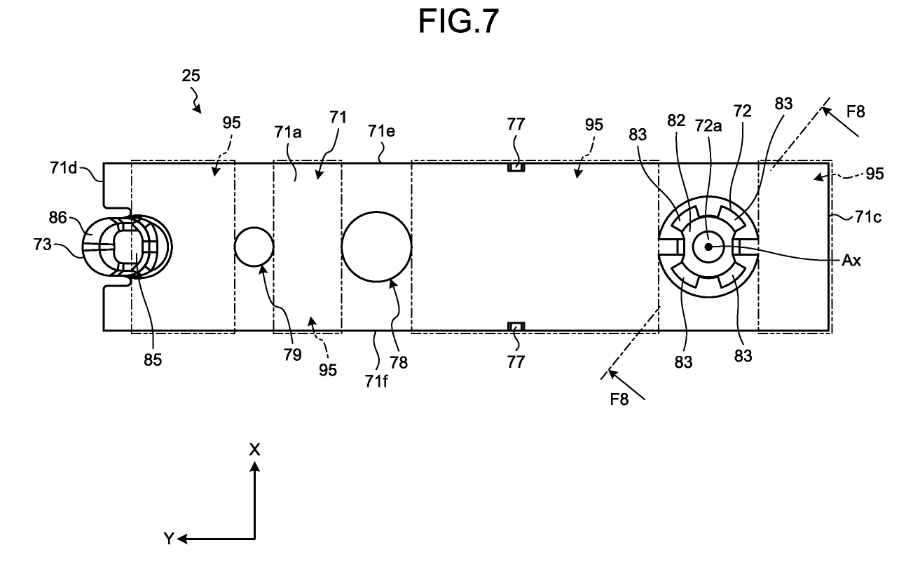

FIG. 6 is a cross-sectional view illustrating the first foreign-object interference member 25 and the bottom wall 31 in the first embodiment. FIG. 7 is a bottom view illustrating the first foreign-object interference member 25 in the first embodiment. As illustrated in FIG. 6 and FIG. 7, the first fitting element 72 includes a protrusion 81, a base 82, and four projections 83. The base 82 may also be referred to as a bottom.

The protrusion 81 protrudes downward from the bottom surface 71a of the plate 71. The protrusion 81 may not continue with the bottom surface 71a and be spaced from the bottom surface 71a. For example, the protrusion 81 may be inserted into a through-hole in the plate 71 from the top to the bottom and be spaced apart from the edge of the through-hole. The protrusion 81 also protrudes downward from the bottom surface 71a in this case. That is, the protrusion 81 hangs downward from or above the bottom surface 71a.

The protrusion 81 is solid and plate-like. The solid protrusion 81 is improved in strength and prevented from deforming. In a plan view of the bottom surface 71a as illustrated in FIG. 7, the protrusion 81 extends in the Y-axis direction. A length of the protrusion 81 in the Y-axis direction is longer than a length (width) in the X-axis direction thereof. The protrusion 81 is not limited to this example. It may have a columnar shape or may be hollow, for example.

As illustrated in FIG. 6, the base 82 is at the bottom end of the protrusion 81. Thus, the base 82 is provided at the bottom end of the protrusion 81 below the bottom surface 71a of the plate 71. The base 82 may be located above the bottom end of the protrusion 81. That is, the first fitting element 72 may have a part below the base 82.

The base 82 forms a bottom surface 72a of the first fitting element 72. The bottom surface 72a is a bottom end face of the first fitting element 72 and is substantially flat. The base 82 has a substantially disc-like shape expanding on the X-Y plane. The cross-section area of the base 82 that intersects the Z-axis is larger than the cross-section area of the protrusion 81 that intersects the Z-axis.

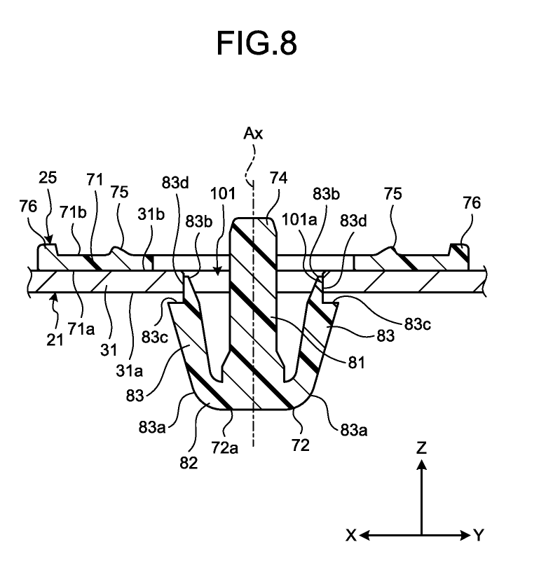

FIG. 8 is a cross-sectional view of the first foreign-object interference member 25 and a part of the bottom wall 31 in the first embodiment, taken along the F8-F8 line in FIG. 7. As illustrated in FIG. 5 and FIG. 8, the four projections 83 extend radially from the base 82 toward the bottom surface 71a of the plate 71. Thus, the projections 83 extends from the protrusion 81, separating away therefrom toward the bottom surface 71a.

The four projections 83 are disposed with spacing about the central axis Ax of the protrusion 81. Two of the projections 83 protrude from the base 82 in a positive X-axis direction. The other two of the projections 83 protrude from the base 82 in a negative X-axis direction.

The distance between the two projections 83 projecting in the positive X-axis direction is substantially equal to the distance between the other two projections 83 projecting in the negative X-axis direction. Meanwhile, the distance between the projection 83 protruding in the positive X-axis direction and the projection 83 protruding in the negative X-axis direction is longer than the distance between any two of the projections 83 protruding in the same positive or negative X-axis direction. The four projections 83 may be disposed at equal intervals.

As illustrated in FIG. 8, each of the projections 83 includes a connecting end 83a and a free end 83b. The connecting end 83a is the bottom end of the projection 83 and connected to the base 82. The free end 83b is the top end of the projection 83 and is spaced from the protrusion 81. Thus, the projections 83 is elastically deformable toward the protrusion 81 with the connecting end 83a serving as a fulcrum.

The projection 83 further includes a first stop surface 83c and a second stop surface 83d. The first stop surface 83c may also be referred to as a first contact. The first stop surface 83c is substantially flat facing upward with spacing from the bottom surface 71a of the plate 71 in the Z-axis direction. The second stop surface 83d is a substantially arc-like curved surface facing oppositely to the central axis Ax.

As illustrated in FIG. 6, the second fitting element 73 includes a protrusion 85 and a projection 86. The protrusion 85 protrudes downward from the bottom surface 71a of the plate 71. The projection 86 projects frontward from the protrusion 85 with spacing below the bottom surface 71a of the plate 71.

The projection 86 includes a stop surface 86a. The stop surface 86a may also be referred to as a second contact. The stop surface 86a is substantially flat facing upward with spacing from the bottom surface 71a of the plate 71 in the Z-axis direction.

In the Z-axis direction, a distance C1 between the first stop surface 83c of the first fitting element 72 and the bottom surface 71a of the plate 71 is longer than a distance C2 between the stop surface 86a of the second fitting element 73 and the bottom surface 71a. The Z-axis direction include a negative Z-axis direction in which the bottom surface 71a faces, and a positive Z-axis direction in which the top surface 71b faces, and may also be referred to as a third direction. The positions of the first stop surface 83c and the stop surface 86a are not limited to this example. For example, in the Z-axis direction, the distance C1 between the first stop surface 83c and the bottom surface 71a may be shorter than or substantially equal to the distance C2 between the stop surface 86a and the bottom surface 71a.

As illustrated in FIG. 4, the first protruding wall 74, the second protruding walls 75, and the third protruding walls 76 protrude upward from the top surface 71b of the plate 71 and extend in parallel in the Y-axis direction. The first protruding wall 74, the second protruding walls 75, and the third protruding walls 76 may protrude or extend in other directions. The first protruding wall 74, the second protruding walls 75, and the third protruding walls 76 are spaced from one another in the X-axis direction.

The first protruding wall 74 is located substantially at the center of the top surface 71b in the X-axis direction. The first protruding wall 74 thereby partitions, into two, the inner space of the lower rail 21 to which the first foreign-object interference member 25 is attached in the X-axis direction. The first protruding wall 74 may be provided in another location. In the Z-axis direction, the first protruding wall 74 is longer in length (height) than the second protruding walls 75 and the third protruding wall 76.

The two second protruding walls 75 are spaced from each other in the X-axis direction. The first protruding wall 74, the first aperture 78, and the second aperture 79 are located between the two second protruding walls 75 in the X-axis direction. That is, in the X-axis direction, the two second protruding walls 75 are provided in different positions from the first aperture 78 and the second aperture 79.

The two third protruding walls 76 protrude from the X-axial, opposite ends of the top surface 71b with spacing in the X-axis direction. The two second protruding walls 75 are located between the two third protruding walls 76 in the X-axis direction. That is, in the X-axis direction, the two third protruding walls 76 are provided in different positions from the first aperture 78 and the second aperture 79.

As illustrated in FIG. 6, the first foreign-object interference member 25 includes an aperture part 91 and an object incliner 92. The aperture part 91 may also be referred to as a first part. The object incliner 92 may also be referred to as a second part. The aperture part 91 and the object incliner 92 are part of the first foreign-object interference member 25. The aperture part 91 and the object incliner 92 are adjacent to each other in the Y-axis direction.

As illustrated in FIG. 4, in the first foreign-object interference member 25, the aperture part 91 is the part including the second protruding walls 75, the third protruding walls 76, the first aperture 78, and the second aperture 79. The object incliner 92 is the part including the first protruding wall 74, the second protruding wall 75, and the third protruding wall 76.

As described above, the aperture part 91 is provided with the first aperture 78 and the second aperture 79. The object incliner 92 is provided with the first protruding wall 74. The first protruding wall 74 is located outside the aperture part 91 in the Y-axis direction.

The first protruding wall 74 includes a first end 74a and a second end 74b in the Y-axis direction. The first end 74a is the end of the first protruding wall 74 in a negative Y-axis direction (rear). The second end 74b is the opposite end of the first end 74a of the first protruding wall 74. In other words, the second end 74b is the end of the first protruding wall 74 in a positive Y-axis direction (front).

The second end 74b is closer to the aperture part 91 than the first end 74a is. In the present embodiment, the second end 74b is located at the end of the object incliner 92 in the positive Y-axis direction and is adjacent to the aperture part 91.

For example, as viewed from the X-axis direction as illustrated in FIG. 6, the object incliner 92 corresponds to the part of the first foreign-object interference member 25 located between the first end 74a and the second end 74b of the first protruding wall 74 in the Y-axis direction. In other words, the object incliner 92 is the part of the first foreign-object interference member 25 behind the second end 74b in the Y-axis direction.

As viewed from the X-axis direction, the aperture part 91 corresponds to the part of the first foreign-object interference member 25 outside the object incliner 92. In other words, the aperture part 91 is the part of the first foreign-object interference member 25 ahead of the second end 74b in the Y-axis direction. In the present embodiment, the aperture part 91 is shorter in length than the object incliner 92 in the Y-axis direction.

The aperture part 91 is provided at the rear end with the first aperture 78 adjacent to the object incliner 92. The front end of the first protruding wall 74 is adjacent to the first aperture 78. Thus, the first protruding wall 74 extends from the first end 71c of the plate 71 to the first aperture 78.

In the present embodiment, the object incliner 92 includes the first fitting element 72, and the aperture part 91 includes the second fitting element 73. The protrusion 81 of the first fitting element 72 is continuous with the first protruding wall 74. In the X-axis direction the length (width) of the protrusion 81 is substantially equal to the length (width) of the first protruding wall 74.

As illustrated in FIG. 4, the two second protruding walls 75 and the two third protruding walls 76 extend across the aperture part 91 and the object incliner 92 in the Y-axis direction. That is, the aperture part 91 and the object incliner 92 include the second protruding walls 75 and the third protruding walls 76.

The third protruding walls 76 extend from one end (the first end 71c) to the other end (the second end 71d) of the top surface 71b in the Y-axis direction. In the Y-axis direction, the first protruding wall 74 is shorter in length than the second protruding walls 75 and the third protruding walls 76.

As illustrated in FIG. 7, the two projections 77 protrude downward from opposite ends of the bottom surface 71a of the plate 71 with spacing in the X-axis direction. In other words, the two projections 77 protrude from the third end 71e and the fourth end 71f, respectively. Thus, the first protruding wall 74 and the two second protruding walls 75 protrude from different positions on the top surface 71b from the two projections 77 in the X-axis direction.

The plate 71 further includes continuous regions 95 in which the bottom surface 71a is continuous between the third end 71e and the fourth end 71f in the X-axis direction. The continuous regions 95 extend in the X-axis direction and is substantially flat. In FIG. 7, the continuous regions 95 are schematically indicated by chain double-dashed lines.

The two projections 77 protrude from one of the continuous regions 95. In other words, the two projections 77 are disposed in locations other than discontinuous regions in the X-axis direction.

The projections 77 are located between the first fitting element 72 and the second fitting element 73 in the Y-axis direction. The two projections 77 are disposed at substantially the same position in the Y-axis direction. In other words, the two projections 77 are aligned with each other as viewed from the X-axis direction.

In the Y-axis direction, the distance between the projections 77 and the first fitting element 72 is shorter than the distance between the projections 77 and the second fitting element 73. The locations of the two projections 77 are not limited to the above locations and may be other locations. For example, the two projections 77 may be disposed in different locations in the Y-axis direction.

In the X-axis direction, the respective lengths (widths) of the projections 77 are shorter than the length (width) of the plate 71. In the Y-axis direction, the projections 77 are shorter in length than the plate 71. In the Z-axis direction, the projections 77 are shorter in length (thickness) than the plate 71. In other words, in the Z-axis direction, the length from the bottom surface 71a to the tip end of each of the projections 77 is shorter than the length from the bottom surface 71a to the top surface 71b of the plate 71. The lengths of the projection 77 are not limited to this example.

The first foreign-object interference member 25 is attached to each of the lower rails 21, for example, in a manner described below. The attachment of the first foreign-object interference member 25 is not limited to the following procedure and operation.

As illustrated in FIG. 6, the bottom wall 31 of the lower rail 21 is provided with a first mounting hole 101, a second mounting hole 102, a first insertion hole 103, and a second insertion hole 104. The first mounting hole 101 may also be referred to as a first hole or a hole. The second mounting hole 102 may also be referred to as a second hole. The bottom wall 31 further includes a first circumferential surface 101a defining the first mounting hole 101 and a second circumferential surface 102a defining the second mounting hole 102.

The first mounting hole 101, the second mounting hole 102, the first insertion hole 103, and the second insertion hole 104 each have a circular cross-section, penetrating the bottom wall 31 in the Z-axis direction and opening to the bottom surface 31a and the inner surface 31b of the bottom wall 31. The first mounting hole 101, the second mounting hole 102, the first insertion hole 103, and the second insertion hole 104 may each have another shape.

The second mounting hole 102 is spaced apart from the first mounting hole 101 in the Y-axis direction. The first insertion hole 103 and the second insertion hole 104 are located between the first mounting hole 101 and the second mounting hole 102 in the Y-axis direction.

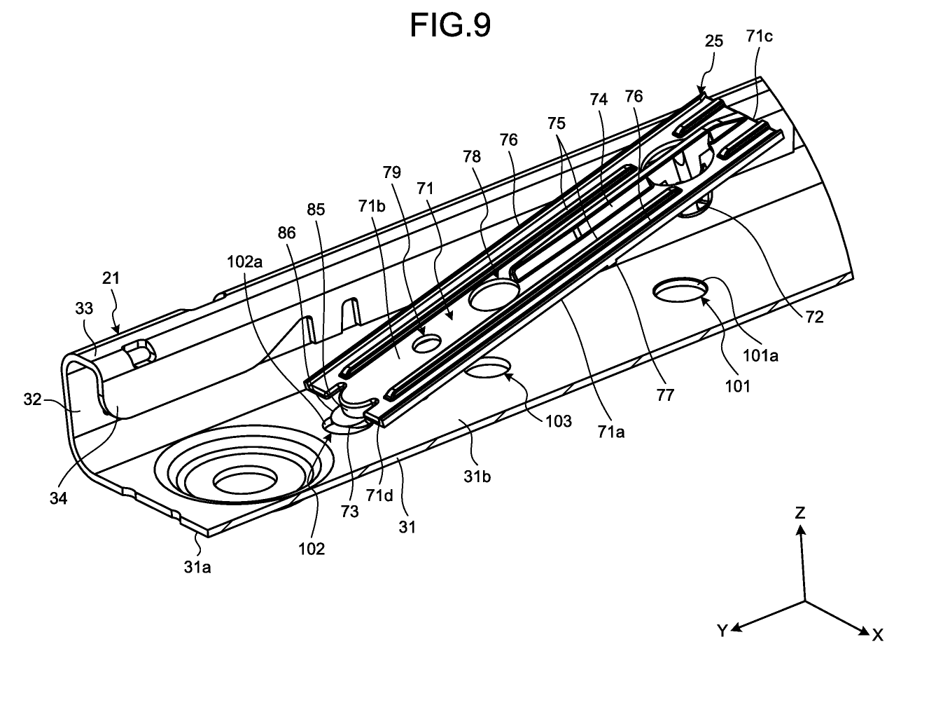

FIG. 9 is a perspective view illustrating the first foreign-object interference member 25 and a part of the lower rail 21 in the first embodiment by which the second fitting element 73 is caught. As illustrated in FIG. 9, first, the second fitting element 73 is inserted into the second mounting hole 102 with the bottom surface 71a of the plate 71 facing the inner surface 31b of the bottom wall 31. The second mounting hole 102 has a size sufficient to allow the second fitting element 73 to pass therethrough.

As illustrated in FIG. 6, the protrusion 85 of the second fitting element 73 is inserted into the second mounting hole 102. In other words, the protrusion 85 passes through the second mounting hole 102. The protrusion 85 makes contact with the second circumferential surface 102a of the second mounting hole 102, which restricts frontward movement of the first foreign-object interference member 25.

The projection 86 is disposed below the bottom wall 31 with the stop surface 86a facing the bottom surface 31a of the bottom wall 31. In other words, the projection 86 is caught by the bottom wall 31. Thus, the bottom wall 31 is disposed between the bottom surface 71a of the plate 71 and the stop surface 86a, which restricts the first foreign-object interference member 25 from moving in the Z-axis direction.

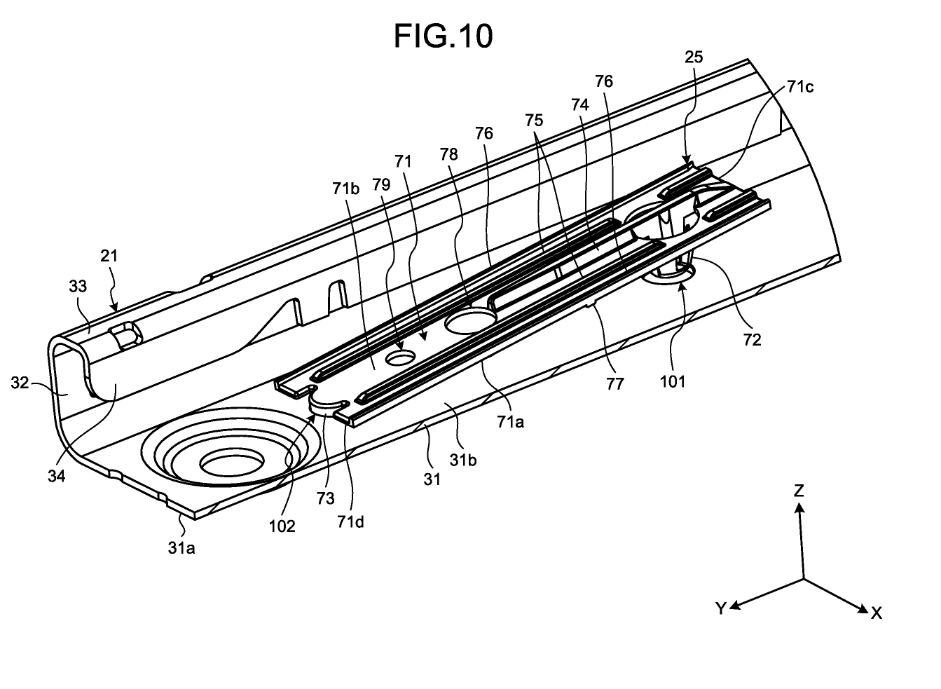

FIG. 10 is a perspective view illustrating the first foreign-object interference member 25 and a part of the lower rail 21 into which the first fitting element 72 is fitted in the first embodiment. As illustrated in FIG. 10, with the second fitting element 73 caught by the bottom wall 31, the first fitting element 72 is inserted into the first mounting hole 101.

For example, the plate 71 turns substantially around the contact between the second fitting element 73 and the second circumferential surface 102a, approaching the bottom wall 31h, whereby the first fitting element 72 approaches the first mounting hole 101. The projections 77 abut on the bottom wall 31. When the projections 77 abut on the bottom wall 31, the first stop surface 83c of the first fitting element 72 is located above the bottom surface 31a. In this case, the first foreign-object interference member 25 has yet to be fixed to the bottom wall 31 and is detachable from the bottom wall 31.

Next, as illustrated in FIG. 6, the plate 71 is elastically deformed so that the first end 71c approaches the bottom wall 31. By the elastic deformation of the plate 71, the first fitting element 72 is inserted into the first mounting hole 101, with the projections 83 elastically deformed. That is, the first mounting hole 101 has a size sufficient to allow the first fitting element 72 to pass therethrough when the projections 83 are elastically deformed toward the protrusion 81. While the projections 83 are not being elastically deformed toward the protrusion 81, the maximum diameter of the first fitting element 72 is larger than the maximum diameter of the first mounting hole 101.

Upon the insertion of the protrusion 81 of the first fitting element 72 through the first mounting hole 101, the projections 83 recover from the elastically deformed state. The base 82 and part of the projections 83 are disposed below the bottom surface 31a.

As illustrated in FIG. 8, after recovering, the first stop surfaces 83c of the projections 83 face the bottom surface 31a of the bottom wall 31. In other words, the projections 83 are caught by the bottom wall 31. Thus, the bottom wall 31 comes between the bottom surface 71a of the plate 71 and the first stop surfaces 83c of the projections 83, thereby restricting the first foreign-object interference member 25 from moving in the Z-axis direction. The first foreign-object interference member 25 is thereby attached to the bottom wall 31.

In addition, the second stop surfaces 83d of the projections 83 face the first circumferential surface 101a of the bottom wall 31. This restricts the first foreign-object interference member 25 from moving along the inner surface 31b of the bottom wall 31.

For example, the projections 83 may maintain the elastic deformation, and using the resilience of the projections 83, the second stop surface 83d may be pressed onto the first circumferential surface 101a. The first foreign-object interference member 25 is thereby more firmly fixed to the bottom wall 31.

As illustrated in FIG. 6, the projections 77 abut on the inner surface 31b of the bottom wall 31, thereby maintaining the elastic deformation of the plate 71. The plate 71 is elastically deformed about the fulcrum being the contact between the projections 77 and the bottom wall 31, and by its resilience, the plate 71 presses the first stop surface 83c of the first fitting element 72 onto the bottom surface 31a of the bottom wall 31 and the stop surface 86a of the second fitting element 73 onto the bottom surface 31a. The first foreign-object interference member 25 is thereby more firmly fixed to the bottom wall 31.

In the Z-axis direction, a length L of each of the projections 77 is equal to or longer than a length found by subtracting a length (thickness) T of the bottom wall 31 from the distance C1 between the bottom surface 71a of the plate 71 and the first stop surface 83c of the first fitting element 72 (L≥C1−T). In the Z-axis direction, the length L of the projection 77 is equal to or longer than a length found by subtracting the length (thickness) T of the bottom wall 31 from the distance C2 between the bottom surface 71a and the stop surface 86a of the second fitting element 73 (L≥C2−T). Because of this, the plate 71 elastically deforms as described above, pressing the first stop surface 83c and the stop surface 86a against the bottom surface 31a of the bottom wall 31. The length L of the projection 77 is not limited to this example.

At the first end 71c and the second end 71d, for example, the bottom surface 71a partially contacts with the inner surface 31b of the bottom wall 31. As described above, the continuous regions 95 are of the bottom surface 71a nearest to the bottom wall 31 of the lower rail 21, extending in the X-axis direction. The bottom surface 71a may be spaced from the bottom wall 31 as long as the first fitting element 72, the second fitting element 73, and the projections 77 can contact with the bottom wall 31.

After the attachment of the first foreign-object interference member 25 to the bottom wall 31, the first aperture 78 of the plate 71 and the first insertion hole 103 of the bottom wall 31 are aligned in communication with each other. This enables a member such as a rivet 105 to pass through the first aperture 78 and the first insertion hole 103 from above. The rivet 105 is, for example, a blind rivet for attaching the bottom wall 31 and the first foreign-object interference member 25 to the floor 1a as illustrated in FIG. 1.

The second aperture 79 and the second insertion hole 104 are aligned in communicate with each other. This enables a member such as a reference pin 106 to pass through the second aperture 79 and the second insertion hole 104 from below. The reference pin 106 is used for, for example, positioning the first foreign-object interference member 25 at the time of measuring the dimensions of the first foreign-object interference member 25 and the lower rail 21 or during the assembly of the slide rail structure 11. This facilitates the assembly of the slide rail structure 11. The first aperture 78 and the second aperture 79 are not limited to these examples.

As illustrated in FIG. 3, foreign objects (objects) 120A and 120B may enter the inside of the lower rail 21 from a gap between the two inner side walls 34. The foreign objects 120A and 120B illustrated in FIG. 3 are exemplified by lighters dropped by a passenger in the vehicle 1. The foreign objects 120A and 120B are not limited to this example.

The foreign object 120A interferes with the first protruding wall 74, for example. Thus, the foreign object 120A is supported by the first protruding wall 74 in an upright or slanting state. In the example of FIG. 3, the foreign object 120A is supported not only by the first protruding wall 74 but also by one of the second protruding walls 75 and one of the inner side walls 34 of the lower rail 21.

The foreign object 120B interferes with one of the third protruding walls 76. A gap between the extremity (top end) of the third protruding wall 76 and the extremity (bottom end) of the corresponding inner side wall 34 of the lower rail 21 is smaller than the thickness of the foreign object 120B, which is a lighter. Thus, the third protruding wall 76 restricts the entry of the foreign object 120B into the gap between the third protruding wall 76 and the inner side wall 34. The foreign object 120B is supported in a slanting state by the third protruding wall 76 and the two inner side walls 34.

The foreign objects 120A and 120B, while supported in upright or slanting state, overlap the upper rail 22 in the Z-axis direction. Thus, while being slid forward, the upper rail 22 can push the foreign objects 120A and 120B forward. Being pushed by the upper rail 22, the foreign objects 120A and 120B are discharged from the inside of the lower rail 21 to the outside.

As described above, the first protruding wall 74, the second protruding walls 75, and the third protruding walls 76 extend in parallel to one another in the Y-axis direction and are spaced from one another in the X-axis direction. This prevents the foreign objects 120A and 120B, when pushed forward, from being caught by the first protruding wall 74, the second protruding walls 75, and the third protruding walls 76, and facilitates the release of the foreign objects 120A and 120B from the inside of the lower rail 21.

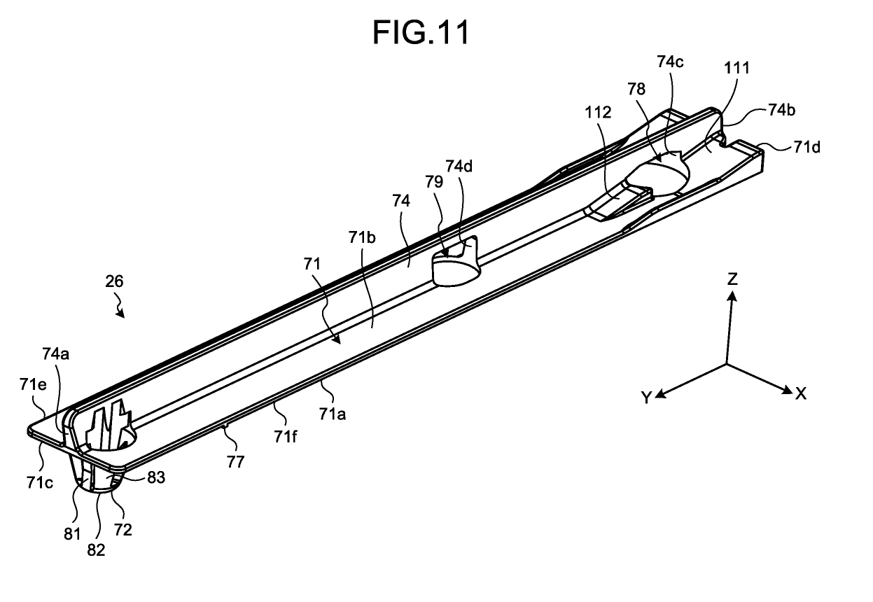

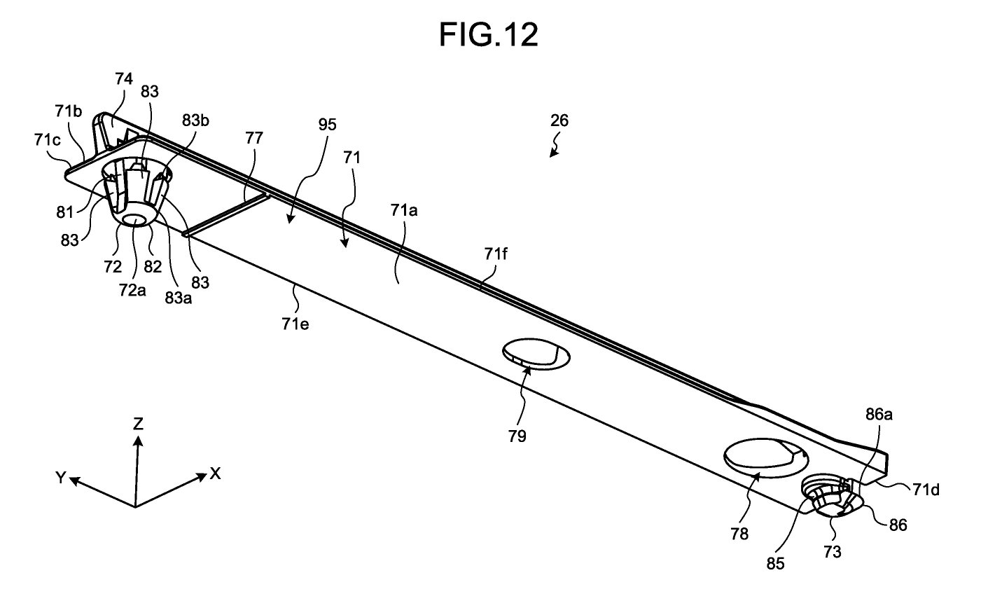

FIG. 11 is a perspective view illustrating the second foreign-object interference member 26 in the first embodiment. FIG. 12 is a perspective view illustrating the second foreign-object interference member 26 in the first embodiment from a different direction from the direction in FIG. 11. The second foreign-object interference members 26 are made from, for example, synthetic resin. The second foreign-object interference members 26 may be made from another material.

The second foreign-object interference member 26 includes the plate 71, the first fitting element 72, the second fitting element 73, the first protruding wall 74, and the projection 77. The plate 71, the first fitting element 72, the second fitting element 73, the first protruding wall 74, and the projection 77 of the second foreign-object interference member 26 are integrally formed but may be formed of, for example, a plurality of members.

In the second foreign-object interference member 26, the first end 71c of the plate 71 is the front end. The second end 71d is the rear end.

In the second foreign-object interference member 26, the first protruding wall 74 extends from the first end 71c to the second end 71d across the first aperture 78 and the second aperture 79. In other words, the first protruding wall 74 covers the first aperture 78 and the second aperture 79 from above. Because of this, the second foreign-object interference member 26 includes no aperture part 91 unlike the first foreign-object interference member 25. The second foreign-object interference member 26 may include the aperture part 91.

The first protruding wall 74 is provided with a first cutout 74c and a second cutout 74d. The first cutout 74c communicates with the first aperture 78. The second cutout 74d communicates with the second aperture 79. Owing to the first cutout 74c and the second cutout 74d, the first protruding wall 74 is prevented from contacting with the member inserted through the first aperture 78 or the second aperture 79.

In the Z-axis direction, the first protruding wall 74 of the second foreign-object interference member 26 is longer in length (height) than the first protruding wall 74 of the first foreign-object interference member 25. This facilitates the formation of the first cutout 74c and the second cutout 74d in the first protruding wall 74.

As illustrated in FIG. 12, the second foreign-object interference member 26 includes the single projection 77 unlike the first foreign-object interference member 25. The projection 77 of the second foreign-object interference member 26 protrudes from the continuous region 95. The projection 77 extends in the X-axis direction between the third end 71e and the fourth end 71f being the X-axial opposite ends of the bottom surface 71a. In other words, the projection 77 extends across the plate 71.

As illustrated in FIG. 11, the second foreign-object interference member 26 further includes a first slope 111 and a second slope 112. The first slope 111 and the second slope 112 rise from the top surface 71b of the plate 71.

The first slope 111 extends from a part provided with the first aperture 78 to the second end 71d of the plate 71. The first slope 111 slopes apart from the top surface 71b toward the rear.

The second slope 112 is located frontward of the first aperture 78 and is adjacent to the first aperture 78. The second slope 112 slopes apart from the top surface 71b toward the rear.

As with the first foreign-object interference member 25, the second foreign-object interference member 26 is attached to the bottom wall 31 with the first fitting element 72 and the second fitting element 73. The first protruding wall 74 supports a foreign object, such as a lighter, in an upright or slanting state. Thus, while the upper rail 22 is slid rearward, the upper rail 22 or the cap 23 pushes the foreign object rearward out of the lower rail 21 to the outside.

When being pushed by the upper rail 22 or the cap 23, the foreign object runs on the first slope 111 and the second slope 112. This prevents the foreign object from interfering with the member such as a rivet projecting upward from the first aperture 78.

In the slide rail structure 11 according to the first embodiment described above, each of the projections 77 is located between the first fitting element 72 and the second fitting element 73 in the Y-axis direction, and abuts on the bottom wall 31 to elastically deform the plate 71 so that the first fitting element 72 and the second fitting element 73 can be pressed against the bottom wall 31. This forms the gap between the bottom wall 31 and the first foreign-object interference member 25 used for elastic deformation of the first foreign-object interference member 25, thereby restricting the first foreign-object interference member 25 from moving relative to the bottom wall 31. Consequently, it is possible to prevent a backlash between the first foreign-object interference member 25 and the bottom wall 31.

The projection 77 protrudes from one of the continuous regions 95. The continuous region 95 is of the bottom surface 71a between the third end 71e and the fourth end 71f in the X-axis direction, and this region is less elastically deformable than a discontinuous region. For example, the upper rail 22 or the locking mechanism 24 may abut on the plate 71 or the first protruding wall 74, pressing the plate 71 downward. In such a case, the plate 71 is less deformable in the periphery of the projection 77, which prevents change of the contact position between the projection 77 and the bottom surface 31a of the lower rail 21. Consequently, regardless of whether the plate 71 is pressed, the projection 77 can continuously abut on the bottom wall 31 of the lower rail 21 at a desired position. Thus, the projection 77 stably abuts on the bottom wall 31 in the same position, preventing a backlash between the first foreign-object interference member 25 and the bottom wall 31.

Two projections 77 protrude from the third end 71e and the fourth end 71f. This allows the two projections 77 to stably abut against the bottom wall 31. Furthermore, the two projections 77 serve to stably support the plate 71 with reduction in increase of weight of the first foreign-object interference member 25 due to the projections 77.

In the Y-axis direction, the two projections 77 are aligned with each other as viewed from the X-axis direction. The plate 71 is thereby prevented from elastically deforming in a twisting manner, with the projections 77 being in abutment against the bottom wall 31. This prevents a backlash between the first foreign-object interference member 25 and the bottom wall 31 because of unintended partial separation of the first fitting element 72 or the second fitting element 73 from the bottom wall 31 or offset of the contact position between the projection 77 and the bottom wall 31. In addition, unintended change of the gap between the third protruding wall 76 and the inner side wall 34 can be avoided, thereby preventing unintentional entry of the foreign objects 120A and 120B in the gap.

The first foreign-object interference member 25 includes the first protruding wall 74 that protrudes from the top surface 71b and extends in the Y-axis direction. The first protruding wall 74 can support, for example, the foreign object 120A, when entered inside the lower rail 21, in an upright or slanting state and help the upper rail 22 push the foreign object 120A from the inside to outside of the lower rail 21. This prevents entry of the foreign object 120A into the gap between the upper rail 22 and the lower rail 21.

In the Y-axis direction, the distance between the projections 77 and the first fitting element 72 is shorter than the distance between the projections 77 and the second fitting element 73. Thus, with the plate 71 elastically deformed by the projections 77, the force with which the first fitting element 72 is pressed against the bottom wall 31 is stronger than the force with which the second fitting element 73 is pressed against the bottom wall 31. In this manner, between the first fitting element 72 and the second fitting element 73 the first fitting element 72 is pressed against the bottom wall 31 with larger force, further preventing a backlash between the first foreign-object interference member 25 and the bottom wall 31. In the present embodiment, for example, providing the projections 77 close to the first fitting element 72, which is inserted into the first mounting hole 101 while elastically deforming, can more effectively prevent a backlash between the first foreign-object interference member 25 and the bottom wall 31.

In the Z-axis direction, the distance C1 between the first stop surface 83c and the bottom surface 71a is longer than the distance C2 between the stop surface 86a and the bottom surface 71a. Thus, the first stop surface 83c is more likely to separate from the bottom surface 31a of the bottom wall 31 than the stop surface 86a. However, the projections 77 cause the plate 71 to elastically deform to press the first stop surface 83c onto the bottom surface 31a with large force. Consequently, the first stop surface 83c is prevented from being separated from the bottom surface 31a, more effectively preventing a backlash between the first foreign-object interference member 25 and the bottom wall 31.

In inserting the first fitting element 72 into the first mounting hole 101, the first fitting element 72 may abut against the bottom wall 31 due to a positional offset in the first foreign-object interference member 25, a dimensional variation, or displacement or a dimensional variation in the first mounting hole 101. Since the projection 83 extends from the base 82 toward the bottom surface 71a, the base 82 more easily abuts against the bottom wall 31 than the projection 83. The base 82 is less deformable than the elastically deformable projection 83. This prevents the first fitting element 72 from being damaged when abutting on the bottom wall 31. The free end 83b of the projection 83 is located in the neighborhood of the base end of the first fitting element 72, and the base 82 and the connecting end 83a of the projection 83 are located in the neighborhood of the tip end of the first fitting element 72. Thus, the connecting end 83a of the projection 83 abuts against the bottom wall 31 more easily than the free end 83b of the projection 83. The connecting end 83a of the projection 83 is less deformable than the free end 83b, which prevents the first fitting element 72 from being damaged when abutting on the bottom wall 31. As described above, the first foreign-object interference member 25 is prevented from being damaged during the attachment.

The free end 83b of the projection 83 is located in the neighborhood of the base end of the first fitting element 72, and the base 82 and the connecting end 83a of the projection 83 are located in the neighborhood of the tip end of the first fitting element 72. Thus, for example, during assembly of the slide rail structure 11 with the first foreign-object interference member 25 being attached to the bottom wall 31, the base 82 or the connecting end 83a of the projection 83 is more likely to abut against another member, such as a rug or a carpet, of the vehicle 1 than the free end 83b of the projection 83. The base 82 and the connecting end 83a of the projection 83 is less deformable than the free end 83b, therefore, the projection 83 is prevented from elastically deforming too greatly to cause the first fitting element 72 to slip out of the first mounting hole 101. That is, the first fitting element 72 is prevented from unintentionally coming off from the bottom wall 31.

When the first fitting element 72 is inserted into the first mounting hole 101, the projection 83 elastically deforms toward the protrusion 81. The projection 83 makes contact with the protrusion 81, and is thereby restricted from further elastically deforming. This can limit the maximum elastic deformation of the projection 83, preventing the projection 83 from being damaged.

The cross-section area of the base 82 that intersects the Z-axis is larger than the cross-section area of the protrusion 81 that intersects the Z-axis. Because of this, the base 82 is less deformable than the protrusion 81. Consequently, the first fitting element 72 is prevented from being damaged if the base 82 runs into the bottom wall 31. That is, the first foreign-object interference member 25 is prevented from being damaged during the attachment.

The second fitting element 73, located in the plate 71 apart from the first fitting element 72 in the Y-axis direction, works for attaching the first foreign-object interference member 25 to the bottom wall 31. Thus, the first foreign-object interference member 25 can be more firmly attached to the bottom wall 31 in multiple locations with spacing in the Y-axis direction with the first fitting element 72 and the second fitting element 73.

The length of the protrusion 81 in the Y-axis direction is longer than the length of the protrusion 81 in the X-axis direction. For attachment to the bottom wall 31 that extends in the Y-axis direction, the first foreign-object interference member 25 may be made long as a whole in the Y-axis direction. For this reason, for example, in attaching the first foreign-object interference member 25 to the bottom wall 31, the bottom surface 71a may be not perfectly horizontal with respect to the bottom wall 31 and inclined to the Y-Z plane. Furthermore, in the present embodiment when the first fitting element 72 is inserted into the first mounting hole 101, the first foreign-object interference member 25 turns substantially around the contact position between the second fitting element 73 and the second circumferential surface 102a on the Y-Z plane. During the insertion, the first fitting element 72 may abut against the bottom wall 31. Moreover, by the resilience of the first foreign-object interference member 25 that has been elastically deformed by the projections 77, for example, the projection 83 of the first fitting element 72 abuts against the bottom wall 31 to cause the projection 83 to come out of the first mounting hole 101. In such cases, Y-Z planar force acts on the protrusion 81. However, owing to the long Y-axial length of the protrusion 81, the strength of the protrusion 81 against the force is improved, preventing the first fitting element 72 from being damaged. The strength of the protrusion 81 can be improved without no increase in the thickness of the protrusion 81 as a whole, thereby achieving cost reduction of the first foreign-object interference member 25.

At least three projections 83 extend radially from the base 82 toward the bottom surface 71a. Thereby, to insert the first fitting element 72 into the first mounting hole 101, the connecting end 83a of at least one of the projections 83 extending in any direction can abut against the bottom wall 31, thereby preventing the protrusion 81 from abutting against the bottom wall 31. That is, the first fitting element 72 is prevented from being damaged. Furthermore, at least one of the projections 83 that extends in any direction can abut against the bottom wall 31, which can prevent the first fitting element 72 moving and coming off from the first mounting hole 101. This can prevent the first fitting element 72 from unintentionally coming off from the bottom wall 31.

The first stop surfaces 83c of the projections 83 face the bottom surface 31a, while the second stop surfaces 83d face the first circumferential surface 101a. This can prevent the first fitting element 72 from unintentionally slipping out from the first mounting hole 101 and the first foreign-object interference member 25 from moving along the bottom surface 71a relative to the bottom wall 31, resulting in preventing a backlash between the first foreign-object interference member 25 and the bottom wall 31.

When inserted into the first mounting hole 101, the projections 83 are elastically deformed, and then, by its resilience the projections 83 stretch to move the second stop surfaces 83d toward the first circumferential surface 101a. By the resilience, the projections 83 can press the second stop surfaces 83d against the first circumferential surface 101a. This can restrict the first foreign-object interference member 25 from moving relative to the bottom wall 31 along the bottom surface 71a, preventing a backlash between the first foreign-object interference member 25 and the bottom wall 31.

The first foreign-object interference member 25 includes the aperture part 91 provided with the first aperture 78 penetrating the first foreign-object interference member 25; and the object incliner 92 adjacent to the aperture part 91 in the Y-axis direction. The first protruding wall 74 is of the object incliner 92 and includes the second end 74b in the Y-axis direction. The second end 74b is one Y-axial end of the object incliner 92. Thus, the first protruding wall 74 does not cover the first aperture 78. This allows a member such as the rivet 105 or the reference pin 106 to pass through the first aperture 78 from above and from below, for example, which facilitates the assembly of the slide rail structure 11. This further prevents a tool or a robot arm for inserting the member such as the rivet 105 through the first aperture 78 from above from interfering with the first protruding wall 74. In addition, the first protruding wall 74 requires no cutouts for avoiding the member such as the rivet 105, reducing the first protruding wall 74 in size.

The second protruding walls 75 are included in the aperture part 91 in a different location from the first aperture 78 in the X-axis direction. The second protruding walls 75 can support, for example, the foreign objects 120A and 120B, if having entered inside the lower rail 21, in upright or slanting state in the aperture part 91 and can help the upper rail 22 push the foreign objects 120A and 120B out of the lower rail 21 to the outside. Consequently, the foreign objects 120A and 120B are prevented from entering the gap between the upper rail 22 and the lower rail 21.

The second protruding wall 75 is not discontinuous at the boundary between the aperture part 91 and the object incliner 92 and extends across the aperture part 91 and the object incliner 92 in the Y-axis direction. The foreign objects 120A and 120B are thereby being prevented from, for example, being caught between the first protruding wall 74 and each of the second protruding walls 75 in the Y-axis direction. Furthermore, in the object incliner 92 the first protruding wall 74 and the second protruding walls 75 can stably support the foreign objects 120A and 120B in an upright or slanting posture.

The first aperture 78 is located between the two second protruding walls 75 in the X-axis direction. This can prevent the first aperture 78 from being covered by the second protruding walls 75, ensuring the opening of the first aperture 78 in the first foreign-object interference member 25. Furthermore, the second protruding walls 75 are located on both sides of the first aperture 78 in the X-axis direction, so that at least one of the second protruding walls 75 can support the foreign objects 120A and 120B, when having entered in the lower rail 21, in upright or slanting state. Consequently, the foreign objects 120A and 120B are prevented from entering the gap between the upper rail 22 and the lower rail 21.

The first protruding wall 74 are located between the two second protruding walls 75. In the Z-axis direction, first protruding wall 74 is longer in length than the second protruding walls 75. Thereby, the first protruding wall 74 can more securely support, in the object incliner 92, the foreign objects 120A and 120B, if entered inside the lower rail 21, in upright or slanting state and can help the upper rail 22 push the foreign objects 120A and 120B out of the lower rail 21 to the outside. Consequently, the foreign objects 120A and 120B are prevented from entering the gap between the upper rail 22 and the lower rail 21.

### Second Embodiment

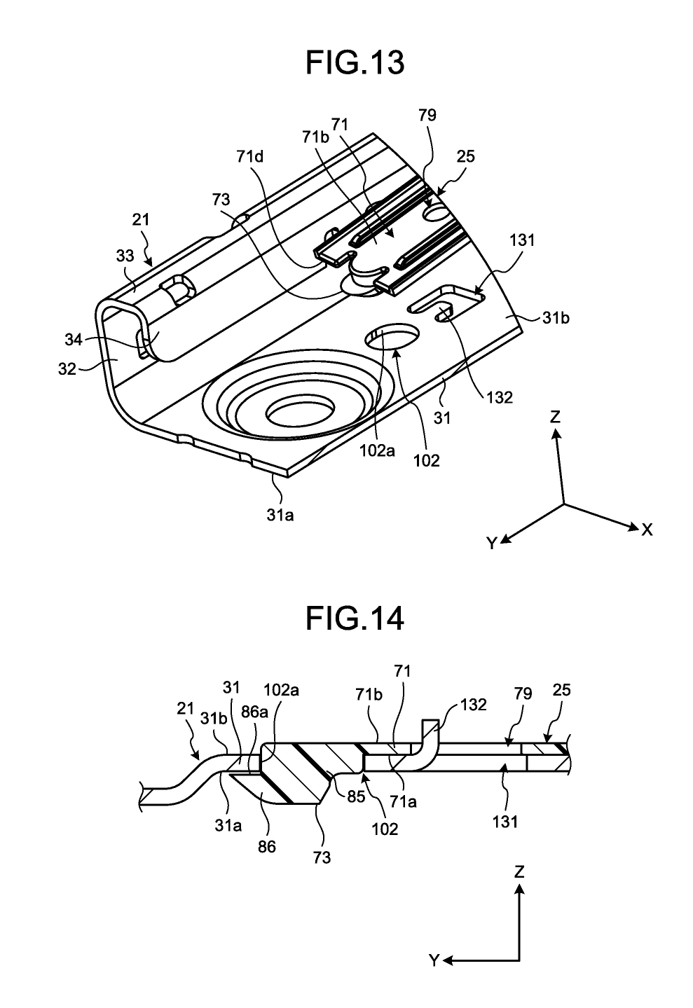

The following describes a second embodiment with reference to FIG. 13 and FIG. 14. In the following description of the embodiment, the same reference signs are used for any constituent elements that have the same functions as constituent elements already described above, and descriptions thereof may be omitted. Among a plurality of constituent elements for which the same reference sign is used, each of them does not necessarily have functions and properties that are totally identical to those of each of the others, and any of the constituent elements may have a function or property that is different from the others depending on each embodiment.

FIG. 13 is a perspective view of a part of the lower rail 21 to which the first foreign-object interference member 25 according to the second embodiment is attached. FIG. 14 is a cross-sectional view illustrating a part of the lower rail 21 and a part of the first foreign-object interference member 25 in the second embodiment.

As illustrated in FIG. 13, the lower rail 21 is provided with an aperture 131 instead of the second insertion hole 104 in the second embodiment. The aperture 131 is located between the second mounting hole 102 and the first insertion hole 103. The aperture 131 communicates with the second aperture 79 in the first foreign-object interference member 25.

The lower rail 21 in the second embodiment includes a tab 132. The tab 132 protrudes from the edge of the aperture 131. As illustrated in FIG. 14, the tab 132 is bent after the attachment of the first foreign-object interference member 25 to the bottom wall 31. The bent tab 132 is located inside the second aperture 79, facing the edge of the second aperture 79.

The protrusion 85 of the second fitting element 73 abuts against the second circumferential surface 102a of the second mounting hole 102, and the tab 132 faces the edge of the second aperture 79. Thereby, the first foreign-object interference member 25 is partially held between the second circumferential surface 102a and the tab 132, and restricted from moving relative to the bottom wall 31 in the Y-axis direction.

In the slide rail structure 11 in the second embodiment described above, the first foreign-object interference member 25 is partially held between the second circumferential surface 102a and the tab 132, thereby preventing a backlash between the first foreign-object interference member 25 and the bottom wall 31.

The above embodiments have described the example of the first foreign-object interference member 25 and the second foreign-object interference member 26 that each include the first fitting element 72 that is attached to the bottom wall 31 while being elastically deformed; and the second fitting element 73 that is caught by the bottom wall 31. However, the first foreign-object interference member 25 and the second foreign-object interference member 26 may each include, for example, two first attachments 72.

In addition to the first foreign-object interference member 25 and the second foreign-object interference member 26, another component or part such as a bracket may include the plate 71, the first fitting element 72, the second fitting element 73, and the projection or projections 77.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle slide rail structure comprising:
a lower rail including a bottom wall extending in a first direction;
an upper rail movably attached to the lower rail in the first direction;
a member including a first surface, two ends in a second direction intersecting the first direction and along the first surface, a continuous region, a first fitting element, and a second fitting element and configured to be attached to the bottom wall with the first fitting element and the second fitting element, the first surface facing the bottom wall, the two ends being on the first surface, the continuous region being of the first surface continuous between the two ends in the second direction, the second fitting element being spaced apart from the first fitting element in the first direction; and
at least one projection located between the first fitting element and the second fitting element in the first direction, protruding from the continuous region, and configured to abut against the bottom wall to elastically deform the member such that the first fitting element and the second fitting element are pressed against the bottom wall.

2. The vehicle slide rail structure according to claim 1, wherein
the at least one projection includes two projections, and
the two projections protrude from the two ends.

3. The vehicle slide rail structure according to claim 2, wherein the two projections are aligned with each other as viewed from the second direction.

4. The vehicle slide rail structure according to claim 1, wherein the member includes
a second surface opposite the first surface, and
a protruding wall protruding from the second surface and extending in the first direction.

5. The vehicle slide rail structure according to claim 1, wherein in the first direction, a distance between each of the projections and the first fitting element is shorter than a distance between each of the projections and the second fitting element.

6. The vehicle slide rail structure according to claim 5, wherein
the bottom wall includes a third surface facing the first surface, a fourth surface opposite the third surface, a first hole, and a second hole, the first hole opening to the third surface and the fourth surface, the second hole opening to the third surface and the fourth surface and spaced apart from the first hole in the first direction,
the member is attached to the bottom wall with the first fitting element and the second fitting element inserted through the first hole and the second hole, respectively,
the at least one projection abuts against the third surface such that the member is elastically deformed to press a first contact of the first fitting element and a second contact of the second fitting element against the fourth surface, and
in a third direction in which the first surface faces, a distance between the first contact and the first surface is longer than a distance between the second contact and the first surface.
